(19) United States
(12) Patent Application Publication
(10) Pub. No.: US 2005/0094343 A1
(43) Pub. Date: May 5, 2005

(54) Decentralized control of motors

(76) Inventor: Richard Calvin Mintz JR., Easley, SC (US)

Correspondence Address: John B. Hardaway, III;NEXSEN PRUET JACOBS & POLLARD, LLC, P.O. Box 10107, Greenville, SC, 29603, US

(21) Appl. No.: 10/698,538

(22) Filed: Oct. 31, 2003

(51) Int. Cl. H02H 5/04

(52) U.S. Cl. 361/104

(57) ABSTRACT

A decentralized control system for group drive installation and method of decentralized control of group drives. The decentralized control system has a data and power input branch having a group installation branch protection, a first drive installation connected to the input branch, at least one additional drive installation connected in parallel with the first drive installation at a load side of the group installation branch protection, and a control line interconnecting the input branch, first drive installation, and subsequent drive installations. Each drive installation includes a field distributor and a geared drive connected to said field distributor. The method of decentralized control of drives on a single branch includes selecting a control protocol, providing a power and data input branch having a group installation branch protection, connecting in series with the input branch at least two drive branches, each of the drive branches having a drive with individual overload protection, and transmitting a control signal based on the selected control protocol from the input branch to the drive branches.

### FIELD OF THE INVENTION

This invention relates generally to control of multiple motor or drive installations, and more particularly to decentralized control of group motor installations using one branch circuit.

### BACKGROUND OF THE INVENTION

Electronic motor installations are commonly used in a host of commercial applications including manufacturing systems. For example, a multiple number of motors may be used to drive a series of conveyors at a manufacturing facility. One consideration when developing and implementing group motor installations is compliance with product safety standards and codes. Group motor installations require specific configurations and components, such as fuses and/or overload protection, in order to fulfill National Electrical Code (NEC) requirements established by National Fire Protection Association (NFPA).

As used herein, the term “drive” is defined to mean electronic variable speed motor controller and includes but is not limited to variable frequency drives (VFD's) and direct current (DC) drives. As used herein, the term “controller” is defined to mean any means to energize a motor and includes but is not limited to contactors and drives. The current practice of group drive installations is to connect separate drives via a single node to a control input, thereby allowing centralized control of the connected drives. For example, FIG. 1A is a schematic diagram of a known group installation, shown generally at 10, in accordance with NEC, and FIG. 1B is a schematic diagram of a known typical motor installation, shown generally at 20. As best shown in FIG 1A. the known group installation 10 includes two or more motors 12 that are connected to one branch circuit, shown generally at 14. A single input 16 having a fuse 18 is connected to the motors 12 by controllers 11. The controllers 11 may include contactors 13 connected to overload protection, shown generally at 15. A contactor is an automatic switch that allows current to flow when the switch is closed. A safety disconnect 17 is connected within fifty feet of each motor 12 to disconnect the motor 12 from the controller 11 or power.

As best shown in FIG. 1B, the typical motor installation uses a main control cabinet 22 having a single input 24 and multiple motors 26 connected to the input 24 via corresponding multiple drive branches 28. From an electrical and product safety standpoint, each of the drive branches 28 has overload protection, shown generally at 30, and fuses 32 are commonly integrated into each drive branch 28 as well as at the single input segment, shown generally at 34. The overload protection 30 is typically coupled with contactors 36 that activate/deactivate the motors 26. A safety disconnect 38 is connected within fifty feet of each drive 26 to disconnect motors or controllers from power. In this centralized control configuration, access to fuses, switches, and overload protection is available at a single location, namely the main control cabinet 22.

One constraint presented by current group drive installations is that the main control cabinet size used for centralized control of group drives is proportional to the number of connected drive branches. Current group drive installations are limited in size due to the limited number of drives that may be connected to the single input before the main control cabinet size becomes too large and too expensive to implement. Additionally, each drive branch generally incurs a cabling and component expense that is required in order to satisfy electrical standards or codes. For example each drive branch that is installed requires individual overload protection, a motor controller, and a motor branch-circuit short-circuit and ground-fault protective device, each of which have an associated cost. From a practical standpoint, the addition of branches to the main control cabinet generally increases field wiring as well as cabling expense.

NEC Article 430.53 (2002 Edition) addresses the use of several motors or loads on one branch circuit. In order to comply with NEC Article 430.53(C), when two or more motors or loads are desired to be connected on the same branch circuit, several requirements must be fulfilled. NEC Article 430.53(C) provides that regardless of the motor rating and branch circuit, two or more motors of any rating, with each motor having individual overload protection, are permitted to be connected to one branch circuit where, among other requirements, the motor controller(s) and overload device(s) are installed as a listed factory assembly and the motor branch-circuit short-circuit and ground-fault protective device either is provided as part of the assembly or is specified by a marking on the assembly. In the past, compliance with NEC Article 430.53 of single branch circuit designs for group VFD controlled motor installations has not been accomplished.

A need exists for a control system for group motor installations that decreases the cabling and component expense required for conventional group motor installations of VFD's. Additionally, a need exists for a control system for group motor installations that minimizes main control cabinet size.

### SUMMARY OF THE INVENTION

An object of this invention is to provide a decentralized control system for group VFD installation.

A more particular object of this invention is to provide a decentralized control system for group VFD installation that reduces the number of branch circuits which reduces implementation costs.

Another more particular object of this invention is to provide a decentralized control system for group VFD installation that allows for a configuration compliant with the National Electric Code regarding group installations of several motors on one branch circuit.

Another more particular object of this invention is to provide a decentralized control system for group VFD installation having overload protection integrated with the VFD's connected to the system.

Another object of this invention is to provide a method of decentralized control of VFD's.

A more particular object of this invention is to provide a method of decentralized control of VFD's that is compliant with the National Electric Code regarding group installations of several motors on one branch circuit.

Another object of this invention is to provide a decentralized control system for group VFD installation that is compatible with a variety of conventional field buses, including but not limited to PROFIBUS, InterBus, DeviceNet, and CANopen.

Another object of this invention is to provide a decentralized control system for group VFD installation that minimizes the amount of space required for occupation in conventional main control cabinets of cabling and components.

Another object of this invention is to provide a decentralized control system for group VFD installation that minimizes the cabling and component expense in comparison with conventional group VFD installations.

These and other objects of the invention are accomplished by providing a method of decentralized control of drives connected on a single branch. The method includes selecting a control protocol, providing a power input branch, or feeder, having group installation branch protection, connecting in series at least two drive branches with the feeder, wherein each of the drive branches have a drive with individual overload protection, and operating each respective drive based on the selected control protocol.

These and other objects of the invention are also accomplished by providing a decentralized control system for group drive installation. The control system includes an input branch having a field bus and a power input branch having a branch protection device and a control power input, a first drive installation connected with the input branch, at least one subsequent drive installation connected in parallel with the first drive installation from a load side of the branch protection device of the input branch, and an interconnecting line connecting the input branch and the drive installations. Each of the drive installations includes a field distributor and a motor connected to the field distributor via a hybrid cable. By connecting additional drive installations via the interconnecting line with the input branch, the amount of cabling and component expense is reduced in comparison with conventional group motor installations.

### BRIEF DESCRIPTION OF THE DRAWINGS

FIG 1A is a schematic diagram of a known group installation.

FIG. 1B is a schematic diagram of a known motor installation.

FIG. 2A is a schematic diagram of a decentralized control system in accordance with a first embodiment of the present invention.

FIG. 2B is a schematic diagram of a decentralized control system in accordance with a second embodiment of the present invention.

FIG. 3 is a perspective schematic view of an application of the decentralized control system in accordance with one embodiment of the present invention.

FIG. 4 is a perspective schematic view of an application of the decentralized control system in accordance with a second embodiment of the present invention.

FIG. 5 is a perspective view of an application of the decentralized control system application in accordance with a third embodiment of the present invention.

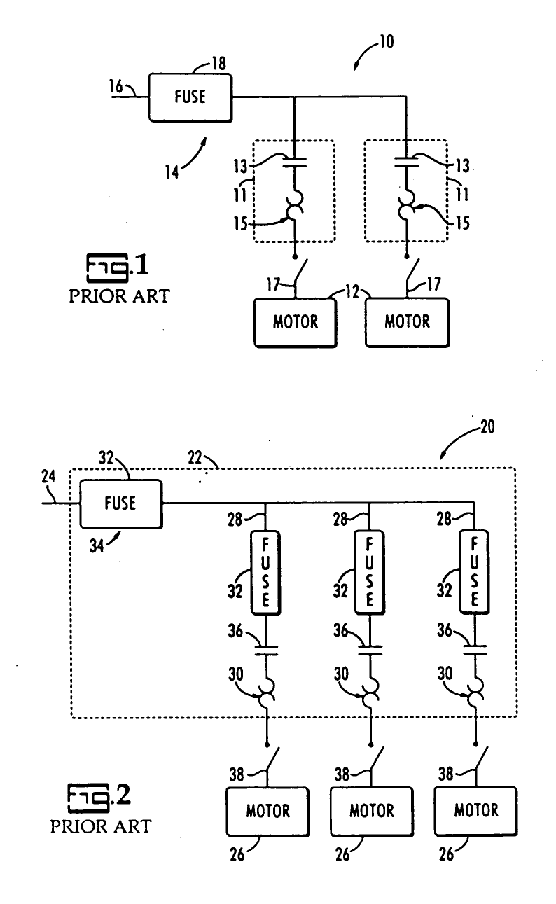

### DETAILED DESCRIPTION OF THE INVENTION

The present invention is a decentralized control system for group drive installation and a method of decentralized control for the same. The invented decentralized control system allows for a group drive installation configuration that is compliant with the National Electric Code regarding group installations of several motors on one branch circuit. In particular, the present invention provides a control system for group drive installations on a single branch having one short circuit and ground fault protection device. Additionally, the present invention provides, a method of decentralized control of variable frequency drives on a single branch.

In a basic form, the decentralized control system includes an input branch having a field bus and a power input branch having a branch protection device and a control power input, a first drive installation connected with the input branch, at least one subsequent drive installation connected in parallel with the first drive installation from the load side of the branch protection device of the input branch, and an interconnecting line connecting the input branch and drive installations. Each of the drive installations includes a field distributor and a motor connected to the field distributor via a hybrid cable. Sensors and actuators may optionally be connected to each of the drive installations depending on a desired application of the group drive installation. A programmable logic controller (PLC), personal computer (PC), or workstation may be used as a host controller to transmit control signals via the field bus. The interconnecting line is a combination of power input branch after leaving branch protection, control power input, and field bus, and preferably has each of the aforementioned provided in a separate conduit or cable.

The term “field bus” is defined herein as a communication system for VFD and sensor/actuator control and provides exchange of data between the VFD and sensor/actuator and a host controller.

The term “field distributor” is defined herein as a module that houses power and control connections, using terminals or conventional plugs, and a field bus communication node and may optionally include motor disconnect and/or a VFD.

The term “hybrid cable” is defined herein as a cable that provides control voltage, motor power, and communication between a field distributor and a motor.

The term “field bus interface” is defined herein as an interface for connection of drive units with conventional discrete input/output (I/O) devices or field buses including, but not limited to PROFIBUS, InterBus, DeviceNet, and CANopen types discussed in further detail hereinbelow. In one embodiment, the field bus interface is a combination of a connection module and plug-in bus electronics. In addition to providing connectability for drive units, field bus interfaces optionally provide motor control and connection of sensors and actuators to the field bus.

PROFIBUS refers to a standardized family of industrial communication protocols widely used in Europe for manufacturing and process applications that allows automation devices, sensors, actuators, and PLCs to communicate with one another over a single bus. Although PROFIBUS type communication devices are specifically mentioned, such as the PROFIBUS type field bus interface, various other communication protocol based devices and interfaces may be used with the invented decentralized control system including but not limited to those based on DeviceNet, InterBus, and CANopen communication protocols.

DeviceNet uses Control and Information Protocol (CIP) to provide control, configure, and data collection capabilities for industrial devices. DeviceNet is ideally suited to connect industrial devices to higher level controllers such as PCs, PLCs, or embedded controllers, and focuses on the interchangeability of devices from different vendors in manufacturing applications. InterBus refers to a protocol that provides high throughput for Input/Output (I/O) networks where I/O data is transmitted in frames that provide simultaneous and predictable updates to all devices on the network. CANopen refers to a Controller Area Network (CAN) based higher layer protocol that is implemented in networks to support interoperability of different devices.

MOVIMOT drives are VFD's based on tuned frequency inverters to produce infinitely variable-speed drives that can be located on geared motors or with field distributors. All requisite control, protection, and monitoring functions of the drive are integrated in the frequency inverter. Although MOVIMOT drives manufactured by SEW Eurodrive are preferably used in the present invention, future SEW Electronic controllers may also be incorporated into the decentralized control system.

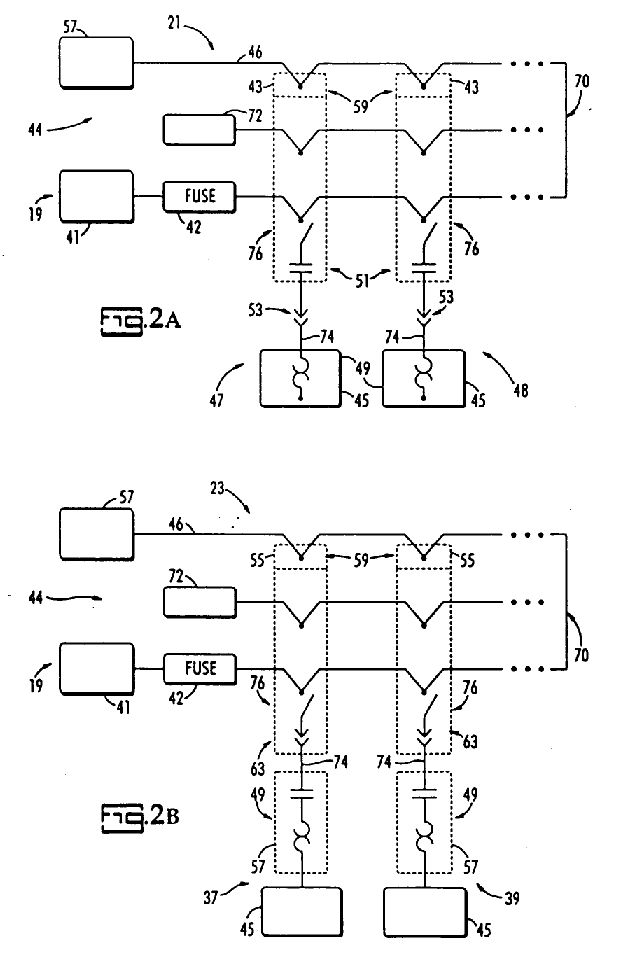

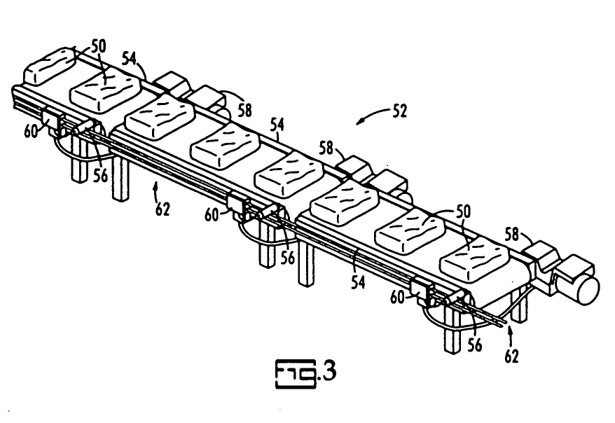

Referring now to the drawings. FIG. 2A is a schematic diagram of a decentralized control system, shown generally at 21, in accordance with a first embodiment of the present invention, and FIG. 2B is a schematic diagram of a decentralized control system 23 in accordance with a second embodiment of the present invention. The system 21, 23 includes an input branch, shown generally at 44, that provides a field bus 46 and a power input branch, shown generally at 19, having a branch protection device 42 and a control power input 72. At least two drive installations, shown generally at 37 (FIG. 2B), 47 (FIG. 2A) and 39 (FIG. 2B), 48 (FIG. 2A), respectively, are each connected to the input branch 44 using an interconnecting line, shown generally at 70, such that the drive installations are connected in parallel with a first drive installation 37, 47 from a load side of the branch protection device 42 of the power input branch 19. A power source 41 provides supply power to the system 21, 23, control power is provided via the control power input 72, and a bus controller 57 transmits and receives data to and from each drive installation using the field bus 46. Control power may be derived from a conventional 24V DC power supply. As best shown in the embodiments of FIGS. 2A and 2B, the field bus 46 is used for conveying the data provided by the input branch 44 to components of the system 21, 23. Although two drive installations are shown in FIGS. 2A and 2B, additional drive installations may be readily connected to the input branch 44.

As shown in FIGS. 2A and 2B, each of the drive installations 37, 39, 47, 48 includes a field distributor 43, 55 and a motor 45 connected to the field distributor via a hybrid cable 74. A field bus interface, shown generally at 59, receives data from the field bus 46 and is preferably incorporated into the field distributor 43 that is in turn connected with a drive and a motor, described in further detail hereinafter. The embodiments shown in FIGS. 2A and 2B are ideally suited for bus communication with corresponding drives. The input branch 44 preferably has a group installation branch protection 42, such as a maximum rated fuse, and each of the drive installations 37, 39, 47, 48 includes integrated overload protection, shown generally at 49. In the embodiment shown in FIGS. 2A and 2B, the field distributors 43, 55 may optionally include motor disconnects 76.

The interconnecting line 70 connects the input branch 44 with the attached drive installations 37, 39, 47, 48 and is a combination of supply power from the power input branch 19 after leaving branch protection 42, control power from the control power input 72, and field bus 46. In a preferred embodiment, the interconnecting line 70 provides each of the supply power, control power, and field bus 46 using separate conduits or cables. The bus control 57 may operate on a number of conventional communication protocols including but not limited to PROFIBUS, DeviceNet, InterBus, and CANopen communication protocols. The field bus 46 is connected to the input branch 44 via a medium appropriate to the particular bus system used including, but not limited to, copper wire and fiber optic.

As best shown in FIG. 2A, the drive installations 47, 48 include field distributors 43, shown in broken line, coupled with drives, shown generally at 51, that are preferably VFD's. The drives 51 are in turn connected to the motors 45 by connectors, shown generally at 53, and hybrid cables 74. In this embodiment, the motors 45 have integrated overload protection. Each of the field distributors 43 has an integrated field bus interface 59 that conveys bus communication to the coupled drive 51. Supply power and control power are conveyed to the field distributor 43 from the input branch 44 using the interconnecting line 70. The hybrid cable 74 conveys supply power and control power from the drive 51 to the motor 45 and communicates data to and from the input branch 44 with the drive 45.

As best shown in FIG. 2B, the drive installations 37, 39 include field distributors 55 that are connected to drives 57, preferably VFD's, by hybrid cables 74 and connectors, shown generally at 63, located on the field distributors 55. The drives 57 are in turn coupled to the motors 45. In this embodiment, the drives 57 have integrated overload protection 49. Supply power and control power are conveyed to the field distributor 55 from the input branch 44 using the interconnecting line 70. Each of the field distributors 55 has an integrated field bus interface 59 that conveys bus communication to the drive 57 via the hybrid cable 74. The hybrid cable 74 also conveys supply power and control power from the field distributor 55 to the drive 57 and coupled motor 45.

When a field distributor is selected, a variety of field bus interfaces are available for selection including but not limited to PROFIBUS, DeviceNet, InterBus, and CANopen. Selection of the particular type of field bus interface 59 depends on the communication protocol selected for the bus control 57. Additionally, the field bus interface 59 may be varied depending on desired inputs/outputs for particular applications of the decentralized control system 21, 23, 40. For example, depending on the number of sensors and or actuators that is desired to be utilized for control of an associated motor, a different field bus interface 59 is selected to accommodate those numbers. M12 connectors may be incorporated with the field bus interface 59 to provide physical connection between the inputs/outputs and the field bus interface 59. The field bus interface 59 may be equipped with light emitting diodes (LED's) and a diagnostic interface that provide a local visual indication of unit status and data communication on the field bus 46.

The method of decentralized control of group drive installation includes selecting a control protocol, providing an input branch having a field bus and a power input branch that has a group installation branch protection and a control power input, connecting in series with the input branch at least two drive installations, each of the drive branches having a drive with individual overload protection, and transmitting a control signal based on the selected control protocol from the input branch to the drive branches. As previously mentioned, the control protocol is preferably selected from PROFIBUS, InterBus, DeviceNet, and CANopen, although other conventional control protocols may be selected. A maximum rated fuse is preferably selected for the group installation branch protection.

The drive branch connecting step includes connecting a first drive branch with the input branch and connecting in parallel with the first drive branch from a load side of the group installation branch protection of the input branch at least one additional drive branch. The interconnecting line is used to connect the drive branches with the input branch. Depending on the selected control protocol a field distributor having an field bus interface that is compatible with the selected control protocol is preferably selected prior to connecting the signal router. Additionally, the signal router preferably includes a disconnect switch for load disconnection and line protection. An example of a signal router includes a field distributor. When a field distributor is selected, a field bus interface is selected that is compatible with the selected control protocol.

Sensors may be connected to the signal router to provide input to the control system. Actuators may also be connected to the signal router to effect desired output for each drive branch. The number of sensors and actuators connected to the signal router vary depending on a desired application of the decentralized control system, examples of which are described hereinbelow.

### EXAMPLES

### Example 1

FIG. 3 is a perspective schematic view of an application of the decentralized control system in accordance with one embodiment of the present invention. Cement bags 50 are transported from one location to another by a conveyor, shown generally at 52, having eight conveyor belts 54 successively placed in a row. Each of the conveyor belts 54 has a power demand of about 0.75 kW and is desired to have a variable speed of from 50% to 100%. A sensor 56 is attached to each conveyor belt 54 to detect when a new cement bag arrives on each conveyor belt. It is desirable that each of the conveyor belts 54 is disconnectable from power supply for maintenance of the conveyor 52.

The equipment description for the conveyor 52 shows a power demand of 0.75 kW and a required speed setting range of 1:2. Eight geared motors 58, such as a MOVIMOT geared motor model type MM07 manufactured by SEW Eurodrive Company with a setting range of 1:5, are each used to drive a conveyor belt 54. For control of the conveyor 52, a programmable logic controller (PLC) having a PROFIBUS field bus interface, not shown, is used in connection with the sensor 56 that is mounted directly on each of the conveyor belts 54. Eight field distributors 60 having PROFIBUS type field bus interface, such as an MFP22D type field bus interface manufactured by SEW Eurodrive Company, each receive input from a corresponding sensor 56 and are connected in series using eight hybrid cables, shown generally at 62. Each of the field distributors 60 are mounted on a conveyor 54 and connected to a geared motor 58. The field distributors 60 include /Z23D field distributor connection modules for PROFIBUS manufactured by SEW Eurodrive Company that couple with the aforementioned MFP22D type field bus interfaces. Each of the eight geared motors 58 has a rated current of 1.9 A resulting in a combined current of 15.2 A for the conveyor 52. Each field bus interface has 4 additional digital inputs and 2 digital outputs via a model M112 connector manufactured by SEW Eurodrive Company. In the case of the /Z23D field distributor 60, a cross-section reduction by one frame size compared to the supply line may be selected for a maximum hybrid cable length of 3 meters. The cross section of the hybrid cables of the supply cores always measures 1.5 mm². A 2 m long hybrid cable is used. The geared motors 58 are freely accessible, and all drives are jointly disconnectable from the supply for maintenance work so that a maintenance switch at each of the field distributors 60 is not required

### Example 2

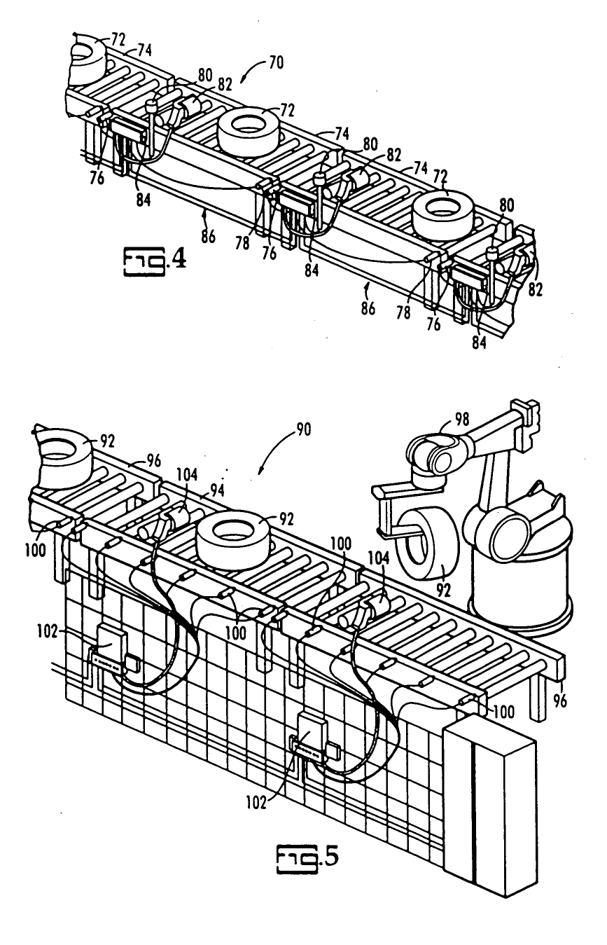

FIG. 4 is a perspective schematic view of an application of the decentralized control system in accordance with a second embodiment of the present invention. In a conveyor, shown generally at 70, used for transporting automobile tires 72, fifteen roller conveyors 74 are each successively placed in a row. Each of the roller conveyors 74 has a power consumption of 0.55 kW, and the speed of the conveyor is desired to be between 33% and 100% via InterBus. A first sensor 76 is located at the front of each roller conveyor 74 to detect the transfer of a tire 72 from the previous roller conveyor. A second sensor 78 is located at the end of each roller conveyor 74 to detect the transfer of the tire to the following roller conveyor. Each roller conveyor 74 is powered only if a tire 72 is located on the conveyor 70. A control light 80 located directly at each roller conveyor 74 indicates the activation of the roller conveyor 74. For maintenance work, the roller conveyors must individually be disconnected from the supply by means of a maintenance switch.

The equipment description shows a power demand of 0.55 kW and a required speed setting range of 3:1. MOVIMOT geared motors or drives 82, such as model type MM05 manufactured by SEW Eurodrive Company with a setting range of 5:1, are selected to drive each roller conveyor 74 and each are freely accessible. An InterBus interface is used for control. Field distributors 84 having InterBus type field bus interface are mounted onto each roller conveyor 74. With the two sensors 76, 78 (takeover and transfer of the tires) and one actuator (control light 80) mounted directly onto each of the roller conveyors 74, an MF122A InterBus field bus interface manufactured by SEW Eurodrive Company with 4 digital inputs and 2 digital outputs via M12 connectors is used with each roller conveyor 74. A /Z16A type field distributor connection module manufactured by SEW Eurodrive Company is selected for coupling with each MF122A InterBus field bus interface. The /Z16A field distributor connection module features an integrated line protection switch in the maintenance switch. The drives 82 are disconnectable from the supply for maintenance work using a maintenance switch at the connected field distributor 84.

Each of the 15 MOVIMOT geared motors 82 has a rated current of 1.6 A. This results in a combined current of 24 A for 15 roller conveyors. For this purpose, a 4 mm² supply line is selected for the field distributors 84. In dimensioning the 24 V supply, 15 MOVIMOT geared motors with a current consumption each of 250 mA, 15 MF122A InterBus field bus interfaces with a current consumption each of 150 mA, 30 sensors with a 90 mA current consumption for each sensor, and 15 actuators with a 200 mA current consumption are taken into account to result in a total current of 11.4 A. The maximum hybrid cable length measures 30 m, even if a cross section reduction is present. A 3 m long hybrid cable, shown generally at 86, is used to connect the field distributors in series 84.

### Example 3

FIG. 5 is a perspective schematic view of an application of the decentralized control system in accordance with a second embodiment of the present invention. In a conveyor, shown generally at 90, for transporting automobile tires 92 two roller conveyors 94, 96 used for tire transport are located in a cell together with a robot arm 98, collectively referred to as a robot cell. The robot arm 98 picks up the tires from one of the roller conveyors 96 and mounts each tire 92 onto a wheel rim. Each of the roller conveyors 94, 96 has a power demand of 0.55 kW. Positioning the tires 92 on a roller conveyor 94 is controlled by means of six sensors 100. Brake motors with a speed setting range of 10:1 are to be used for the positioning task. The control in the robot cell is carried out via a DeviceNet interface, which will also be used to control the two roller conveyors 94, 96 of the robot cell. A switch cabinet of the robot cell does not have sufficient space to contain inverters of both roller conveyors 94, 96. The remote location of inverters away from the roller conveyors 94, 96 must be a design consideration.

The equipment description shows a power demand of 0.55 kW and a required speed setting range of 10:1. Therefore, field distributors 102 with integrated frequency inverters that are mounted outside of a hazardous area of the robot arm 98 are to be used. Each of these field distributors 102 are located 5 m away from the corresponding roller conveyors 94, 96. A geared. motor in delta connection is required. The method of connection of the motor is implemented in the field distributor and, therefore, must be taken into consideration when selecting the field distributor. Since the frequency inverter is not mounted directly on the motor, the motor must also be equipped with a TH thermostat to protect it from thermal overload. Based on the selected motor and the method of connection, two MOVIMOT geared motors 104 of type MM05 manufactured by SEW Eurodrive Company are each mounted on one of the roller conveyors 94, 96. An additional braking resistor is not required since the MOVIMOT geared motor 104 uses the brake coil of the utilized braking motor as a braking resistor.

A DeviceNet fieldbus interface is required for control. The six sensors 100 are installed on each of the roller conveyors 94, 96. Each of the field distributors 102 include an MFD32A DeviceNet fieldbus interface manufactured by SEW Eurodrive Company with six digital inputs via M12 connector. Since the roller conveyors 94, 96 are in the hazardous area of the robot arm 98, it was required to integrate the MOVIMOT inverters in the field distributor 102. Based on the selected MOVIMOT geared motor 104 and the selected field bus interface for DeviceNet, an MFD32A/MM05B/Z38A 1/AF1 field distributor is used. For dimensioning the 24 V supply, two MOVIMOT geared motors with frequency inverters having a current consumption each of 250 mA and twelve sensors each with 80 mA current consumption are taken into account. This results in a total current of 1.46 A. The voltage supply for the two MFD32A DeviceNet field bus interfaces is carried out via DeviceNet.

For the MFD32A/MM05B/Z38A 1/AF1 field distributor, the maximum length of the hybrid cable between motor and field distributor with mounted frequency inverter measures 5 m. Two hybrid cables of 5 m cable length between the field distributors 102 and geared motors 104 per robot cell are used.

Those of ordinary skill in the art will be aware of other variations that are within the scope of the claimed invention, which is to be measured by the following claims.

1. A method of decentralized control of variable frequency drives on a single branch comprising the steps of:
selecting a control protocol;
providing a power input branch having a single group installation branch protection;
connecting in series with the input branch at least two drive branches with the input branch, each of the drive branches having a drive with individual overload protection; and
transmitting a control signal based on the selected control protocol from the input branch to the drive branches.

2. A method according to claim 1, wherein said control protocol selecting step comprises selecting the control protocol from PROFIBUS, InterBus, DeviceNet, and CANopen.

3. A method according to claim 1 further comprising selecting a maximum rated fuse for the group installation branch protection.

4. A method according to claim 1, wherein said drive branch connecting step comprises:
connecting a first drive branch with the input branch; and
connecting in parallel with the first drive branch from a load side of the group installation branch protection of the input branch at least one additional drive branch;
wherein said drive branches include a field distributor connected with a drive.

5. A method according to claim 4 further comprising selecting a field distributor based on the selected control protocol prior to said drive branch connecting step.

6. A method according to claim 5, wherein the field distributor has a disconnect switch for load disconnection.

7. A method according to claim 6 further comprising selecting a field bus interface of the field distributor based on the selected control protocol when selecting the field distributor.

8. A method according to claim 4 further comprising connecting at least one of at least one sensor and at least one actuator to the field distributor.

9. A method according to claim 1 further comprising selecting a control input from a programmable logic controller, personal computer, and workstation, prior to said control signal transmitting step.

10. A method of decentralized control of variable frequency drives on a single branch comprising the steps of:
providing an input branch having a single group installation branch protection;
connecting in series at least two field distributors to the input branch, each of the field distributors having a disconnect switch for load disconnection and line protection;
connecting a drive having integrated overload protection to each of the field distributors; and
transmitting a control signal from the input branch to the field distributors.

11. A method according to claim 10 further comprising:
selecting a control protocol prior to said input branch providing step; and
selecting a field bus interface for the field distributors based on the selected control protocol.

12. A method according to claim 11, wherein said field bus interface selecting step is performed by selecting from PROFIBUS, InterBus, DeviceNet, and CANopen type interfaces.

13. A method according to claim 10 further comprising selecting the drive from a variable speed drive and a fixed speed drive prior to said drive connecting step.

14. A method according to claim 10, wherein said drive connecting step is performed using a plug connector.

15. A method according to claim 10 further comprising selecting a maximum rated fuse for the group installation branch protection.

16. A method according to claim 10 further comprising the step of selecting a control input from a programmable logic controller, personal computer, and workstation, prior to said control signal transmitting step.

17. A control system for group drive installations on a single branch, said system comprising:
an input branch having a group installation branch protection;
a first drive installation connected with said input branch;
at least one subsequent drive installation connected in parallel with said first drive installation at a load side of said group installation branch protection, each of said first drive installation and said at least one subsequent drive installation comprising:
a field distributor; and
a motor connected to said field distributor; and
an interconnecting line connecting said input branch, said first drive installation, and said at least one subsequent drive installation.

18. A control system according to claim 17, wherein said input branch comprises:
a field bus; and
a power input branch having a power supply connected to the group installation branch protection and a control power input.

19. A control system according to claim 18 further comprising a bus controller connected to said field bus, wherein said bus controller transmits a signal to control said geared drive.

20. A control system according to claim 19, wherein said bus controller is selected from a programmable logic controller, a personal computer, and a workstation.

21. A control system according to claim 19 further comprising at least one actuator connected to said field distributor, wherein said at least one actuator is controlled by a signal transmitted from said bus controller.

22. A control system according to claim 17, wherein said field distributor comprises:
a field bus interface; and
a field distributor connection module coupled with said field bus interface.

23. A control system according to claim 22, wherein said field distributor connection module comprises at least one digital input connector and at least one digital output connector.

24. A control system according to claim 22, wherein said field bus interface is selected from an interface compatible with one of DeviceNet, InterBus, CANopen, and PROFIBUS protocols.

25. A control system according to claim 17, wherein said field distributor comprises an integrated frequency inverter.

26. A control system according to claim 18, wherein said interconnecting line comprises power input branch after leaving branch protection, control power input, and field bus.

27. A control system according to claim 17, wherein said field distributor is connected to said motor via a hybrid cable.

28. A control system according to claim 27, wherein said field distributor has a motor disconnect.
